(19) United States
(12) Patent Application Publication
(10) Pub. No.: US 2008/0175592 A1
(43) Pub. Date: Jul. 24, 2008

(54) WPON Architecture using Model-Locked Laser with Nonlinear Dispersive Fiber WDM Light Source and Colorless ONU

(75) Inventor: Yuxin DAI, Santa Rosa, CA (US)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 11/851,698

(22) Filed: Sep. 7, 2007

Related U.S. Application Data
(60) Provisional application No. 60/826,761, filed on Sep. 25, 2006.

(51) Int. Cl. H04J 14/02

(52) U.S. Cl. 398/87; 398/79; 398/81; 398/82

(57) ABSTRACT

A passive optical network component comprising a model-locked laser, a dispersive nonlinear fiber coupled to the model-locked laser, and a modulator coupled to the dispersive nonlinear fiber, wherein the model-locked laser provides wavelengths for downstream modulations and enables upstream transmissions from a colorless optical network unit (ONU). Also disclosed is a colorless ONU comprising an optical circulator coupled to an incoming optical path and an outgoing optical path, and an optical injection-locking component coupled to the optical circulator, wherein the colorless ONU uses downstream optical signals from a model-locked laser as seed light to enable colorless upstream transmissions.

### CROSS-REFERENCE TO RELATED APPLICATIONS

The present application claims priority to U.S. Provisional Patent Application Ser. No. 60/826,761 filed Sep. 25, 2006 by Dai and entitled “WPON Architecture Using Model-Locked Laser with Nonlinear Dispersive Fiber WDM Light Source and Colorless ONU,” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A passive optical network (PON) is one technology that provides network access over “the last mile.” The PON is a point to multi-point network comprised of an optical line terminal (OLT) at the central office, an optical distribution network (ODN), and a plurality of optical network units (ONUs) at the customer premises. For next generation PON technologies, a wavelength division multiplexed (WDM) passive optical network (WPON) has been proposed to provide higher bandwidth per user and to support more users that other candidate technologies, such as Gigabit PON (GPON) or Ethernet PON (EPON). Various implementations of WPON exist. Among these, colorless transmission technology is attractive since it uses low cost optical sources, such as Fabry-Perot laser diodes (FP LDs) or vertical-cavity surface-emitting lasers (VCSELs).

In colorless WPON transmission schemes, broadband light sources (BLSs) are traditionally used as “seed” light in order to trigger narrowband light transmission in FP LDs or VCSELs at the OLT and/or the ONU, a mechanism known as injection-locking. Injection-locking is a mechanism that generates high efficiency light from a lower efficiency “seed” light at the same wavelength. Unfortunately, the use of BLSs increase system cost and cause additional maintenance burdens on systems that employ combined PON technologies. For instance, additional optical blocking filters are required for BLSs when a WPON and a GPON coexist in the same optical distribution network (ODN). In other colorless WPON systems, a BLS is eliminated by using dense wavelength division multiplexing (DWDM) distributed feedback (DFB) lasers at the OLT for downstream transmission and to induce injection-locking at the ONUs. However, the use of a DFB laser for every wavelength significantly increases total cost as well as maintenance requirements, especially when a system supports hundreds of wavelengths. Thus, a need exits for an improved WPON that effectively and economically generates multi-wavelengths for downstream transmission and effectively and economically enables colorless ONUs without using a BLS.

### SUMMARY

In one embodiment, the disclosure includes a passive optical network component comprising a model-locked laser, a dispersive nonlinear fiber coupled to the model-locked laser, and a modulator coupled to the dispersive nonlinear fiber wherein the model-locked laser provides wavelengths for downstream modulations and enables upstream transmissions from a colorless ONU.

In another embodiment, the disclosure includes a colorless ONU comprising an optical circulator coupled to an incoming optical path and an outgoing optical path, and an optical injection-locking component coupled to the optical circulator, wherein the colorless ONU uses downstream optical signals from a model-locked laser as seed light to enable colorless upstream transmissions.

In a third embodiment, the disclosure includes a method comprising generating an optical pulse comprising a plurality of wavelengths, modulating the optical pulse at at least one of the wavelengths, and transmitting the modulated optical pulse to an optical component on an outgoing path, wherein the optical pulse induces injection-locking in the optical component for transmission to an incoming path.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of one embodiment of a WPON system.

FIG. 2A is a schematic diagram of one embodiment of an OLT.

FIG. 2B is a schematic diagram of another embodiment of an OLT.

FIG. 2C is a schematic diagram of another embodiment of an OLT.

FIG. 3A is a schematic diagram of one embodiment of an ONU.

FIG. 3B is a schematic diagram of another embodiment of an ONU.

FIG. 3C is a schematic diagram of another embodiment of an ONU.

FIG. 3D is a schematic diagram of another embodiment of an ONU.

FIG. 4 is a flowchart of one embodiment of a WPON method.

FIG. 5 is a schematic diagram of one embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a WPON configuration comprising a narrow pulse model-locked laser coupled with a high dispersion optical fiber at an OLT. The combination of the short pulse model-locked laser and the high dispersion fiber generates a broadened pulse at the OLT that contains a large number of individual wavelengths. The wavelengths may be modulated jointly or individually by one or a plurality of modulators at the OLT. The combined wavelengths may be transported downstream through a dedicated downstream path in an ODN. An arrayed waveguide grating (AWG) router in the ODN may separate the wavelengths into a plurality of single wavelength channels. The plurality of signal wavelength channels may be redirected into the individual colorless ONUs. At each ONU, the single wavelength channel may be branched, using a coupler, into a downstream path towards an ONU receiver, and an upstream path towards an ONU transmitter. At the transmitter path, an optical circulator may be used to redirect the single wavelength channel for injection locking with a FP LD or a VCSEL. The optical circulator may then redirect and transmit the upstream amplified single wavelength channel from the FP LD or VCSEL towards the ODN. The AWG router collects the transmitted upstream single wavelength channels from the individual ONUs and transports the combined wavelengths upstream to the OLT through a dedicated upstream path in the ODN. At the OLT, the combined upstream wavelengths may be separated by a second AWG router into a plurality of single wavelength channels that may be collected by a receiver array. This WPON architecture may provide a large number of downstream wavelengths economically with a single model-locked laser and may effectively induce injection locking for upstream transmissions.

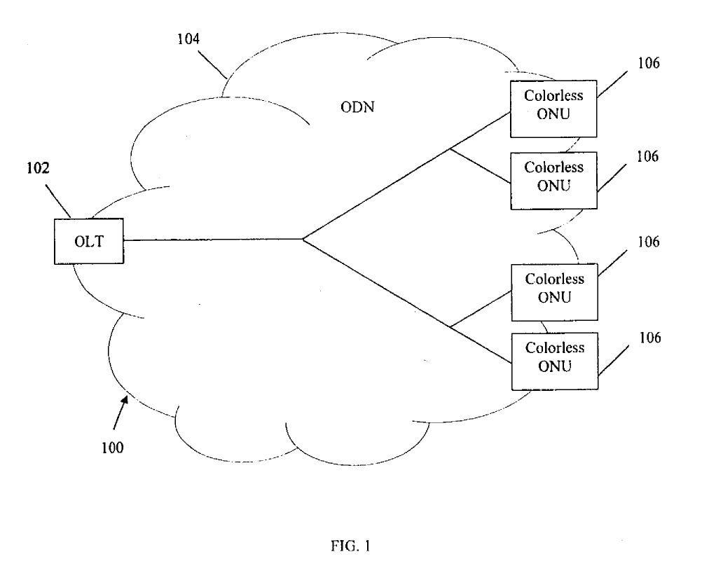

FIG. 1 illustrates one embodiment of a WPON 100. The WPON 100 comprises an OLT 102, an ODN 104, and a plurality of ONUs 106, which may be colorless ONUs 106. The WPON 100 is a communications network that does not require any active components to distribute data between the OLT 102 and the ONUs 106. Instead, the WPON 100 uses the passive optical components in the ODN 104 to distribute data between the OLT 102 and the ONUs 106. The WPON 100 uses multiple optical wavelengths to increase the upstream and/or downstream bandwidth available to end users. The WPON may provide more bandwidth over longer distances by dedicating more optical bandwidth to each user and by reducing optical losses in ODN. In some embodiments, the multiple wavelengths of a WPON 100 may be used to separate the ONUs 106 into a plurality of virtual PONs co-existing on the same physical infrastructure. Alternatively, the wavelengths may be used collectively through multiplexing to provide efficient wavelength utilization and lower delays experienced by the ONUs 106.

The OLT 102 may be one component of the WPON 100. In an embodiment, the OLT 102 may be any device that is configured to communicate with the ONUs 106 and another network (not shown). Specifically, the OLT 102 may act as an intermediary between the other network and the ONUs 106 in that the OLT 102 forwards data received from the network to the ONUs 106, and forwards data received from the ONUs 106 onto the other network. In an embodiment, the OLT 102 may comprise a narrow pulse generating source and a receiver array, as explained in detail below. If the other network is a non-optical network that uses a different protocol than that of the WPON 100, such as Ethernet or SONET/SDH, then the OLT 102 may also comprise a converter that converts the other network's data into the WPON's protocol, and converts the WPON's data into the other network's protocol. The OLT 102 may be located at a central location, such as a central office, or may be located at other locations as well.

The ONUs 106 may be another component of the WPON 100. The ONUs 106 may be any devices that are configured to communicate with the OLT 102 and a customer or user (not shown). Specifically, the ONUs may act as an intermediary between the OLT 102 and the customer, wherein the ONUs 106 forward data received from the OLT 102 to the customer, and forward data received from the customer onto the OLT 102. In an embodiment, the ONUs 106 may comprise a transmitter configured to send optical signals to the OLT 102, an optical receiver configured to receive optical signals from the OLT 102, and a converter that converts the optical signal into electrical signals for the customer, such as signals in the ATM or Ethernet protocol. The ONUs 106 may also comprise a second transmitter and/or receiver that sends and/or receives the electrical signals to a customer device. The ONUs may be located at distributed locations, such as the customer premises, or may be located elsewhere.

Another component of the WPON 100 may be the ODN 104. The ODN 104 is a data distribution system comprised of optical fiber cables, couplers, splitters, distributors, and/or other equipment known to persons of ordinary skill in the art. In an embodiment, the optical fiber cables, couplers, splitters, distributors, and/or other equipment known to persons of ordinary skill in the art are passive optical components. Specifically, the optical fiber cables, couplers, splitters, distributors, and/or other equipment known to persons of ordinary skill in the art may be components that may not require any power to distribute data signals between the OLT 102 and the ONUs 106. The ODN 104 may extend from the OLT 102 to the ONUs 106 in a branching configuration as shown in FIG. 1, or may be alternatively configured as determined by a person of ordinary skill in the art.

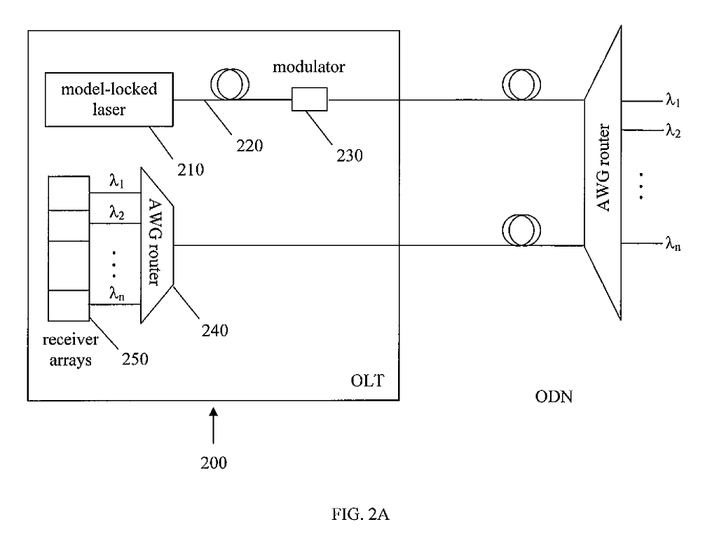

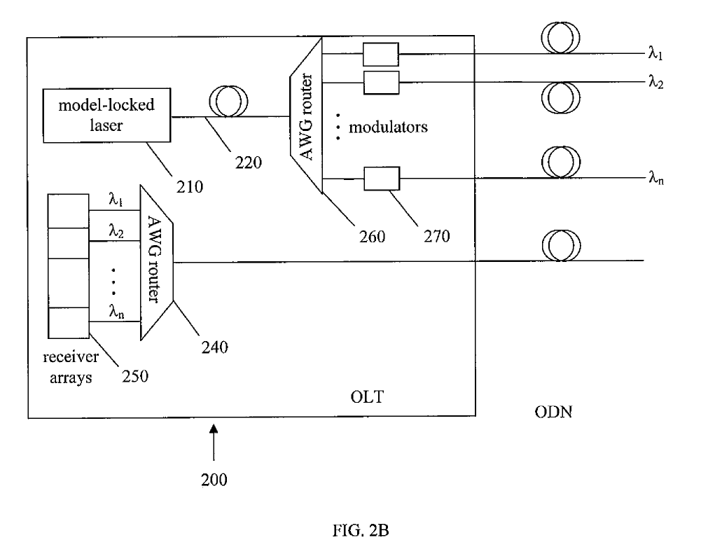

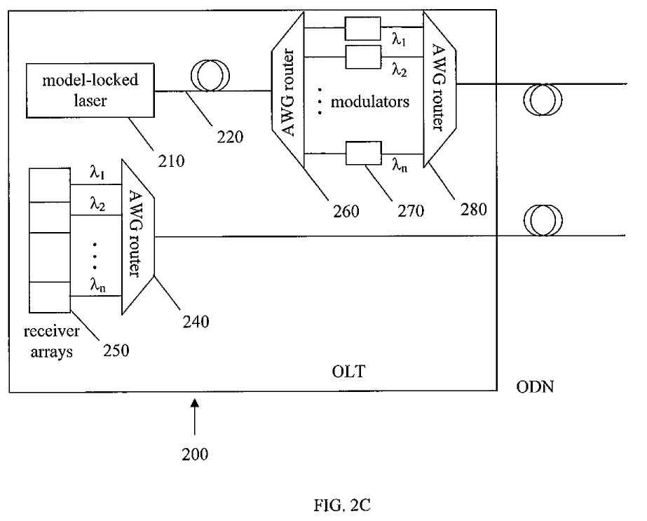

FIG. 2A illustrates one embodiment of an OLT 200 in the WPON system. Specifically, the OLT 200 may include a single model-locked laser 210, a dispersive nonlinear fiber 220, a modulator 230, an optical router 240, and a receiver array 250. The single model-locked laser 210 may generate a short pulse array with period from about a few picoseconds to about a few femtoseconds. A single model-locked laser may be any passive or active model-locked laser that emits extremely short time pulses, such as those on the order of about a few picoseconds to about a few femtoseconds. The dispersive nonlinear fiber 220 is a specialty fiber known to persons of ordinary skill in the art, which may cause a broadening in the laser pulse and thus increase the number of modes of the model-locked laser. The modulator 230 may be any optical or electro-optical device that modulates the light signal in a controlled manner. In an embodiment, the combined wavelengths may be modulated by the modulator 230 without being separated into individual wavelengths. The modulator may modulate the broadened laser pulse, which may comprise the combined wavelengths. The wavelengths may then be transmitted jointly downstream from the OLT 200 to the ODN via a single fiber, such as a G.652 single mode fiber (SMF). At some point in the ODN, the combined wavelengths may be separated by an external router into a plurality of single wavelength channels (designated by λₙ in FIG. 2A). The combined wavelengths may also be separated into any number of narrowband channels. The optical router 240 may be an AWG router that receives upstream combined wavelengths from the ONUs, via at least one upstream fiber and perhaps through the same external router used for downstream transmission. Using current technologies, the insertion loss of the AWG, which is independent from the number of combined wavelengths, is about 5 dB. A WPON using about 50 GHz spacing ITU grade DWDM may support about 100 users over distances longer than about 20 km. The number of users that may be supported by the WPON exceeds considerably the number of users supported by GPON/EPON, which may be about 32 users over a distance of no more than 20 km and about 64 users over a distance of no more than 10 km. In another embodiment, the optical router 240 of the ONU 200 may be a thin film filter. The optical router 240 may separate the combined wavelengths into a plurality of channels that are fed into the receiver array 250.

FIG. 2B illustrates another embodiment of the OLT 200. The downstream combined wavelengths may be separated into a plurality of single wavelength channels by an additional AWG 260 at the OLT 200. In this embodiment, the single modulator 230 that modulates a broad pulse is replaced by a plurality of modulators 270. Each individual modulator 270 may be used to modulate one separated wavelength channel at the OLT 200. The modulated single wavelength channels may then be transmitted to the ODN. Modulating the single wavelength channels individually will allow carrying different information to the corresponding ONUs over the WPON. Such modulation schemes may also simplify the media access control (MAC) layer and enables low speed detection at the ONUs.

Another embodiment of the OLT 200 is shown in FIG. 2C. In this embodiment, the single wavelength channels that are modulated individually by the modulators 270 may be further recombined into combined downstream wavelengths via an additional optical router 280 at the OLT 200. The combined wavelengths may then be transmitted downstream more efficiently from the OLT 200 via a single fiber through the ODN. In embodiments of the OLT 200, no BLS component is required or a plurality of combined wavelength channels for either transmitting data to the ONUs or receiving data from the ONUs through the ODN. Instead, a model-locked laser and a dispersive nonlinear fiber may substitute for a BLS to generate the broadband light or the plurality of combined wavelength channels.

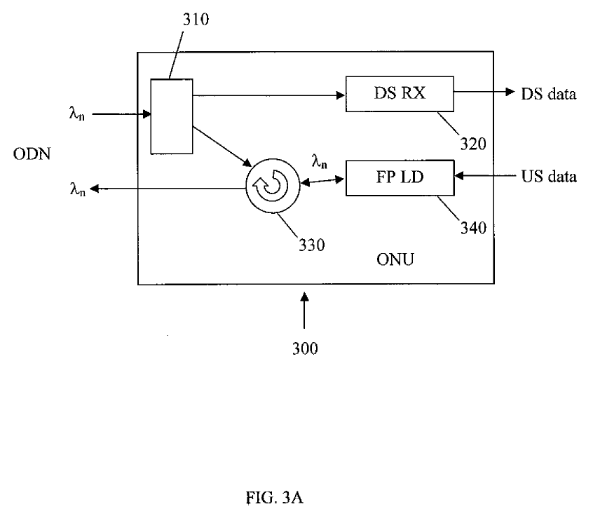

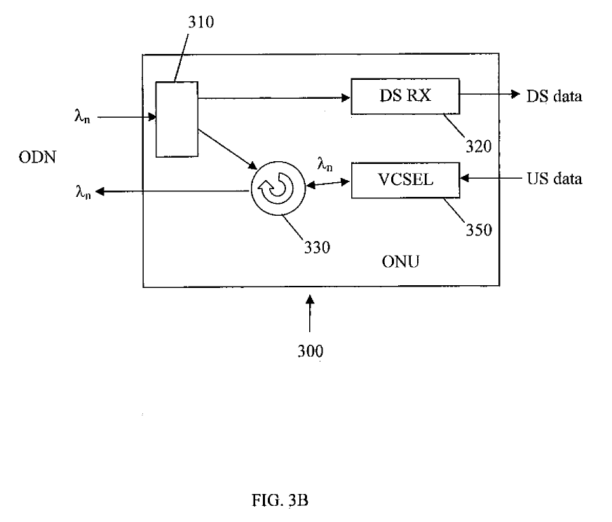

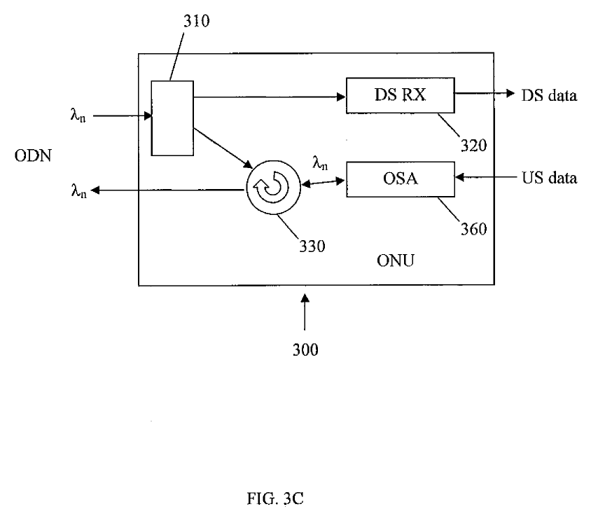

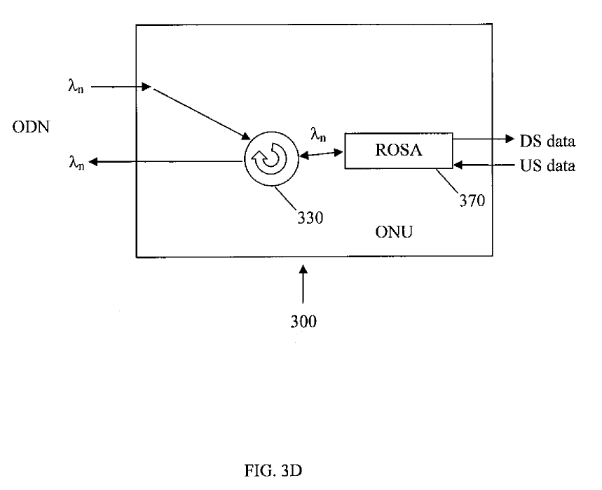

FIG. 3A illustrates one embodiment of a colorless ONU 300 in the WPON system. Specifically, the ONU 300 may include a one-by-two (1×2) coupler 310, an optical signal receiver 320, an optical circulator 330, and a FP LD 340. The 1×2 coupler 310 may be any passive optical device, such as a device comprising two fused fibers, which may receive a downstream optical signal from an input port, split the optical signal into two downstream signals, and sends the two downstream signals over two branched output ports into two separate paths. The 1×2 coupler 310 may send the first downstream branched signal to the optical signal receiver 320, and send the second downstream branched signal to the optical circulator 330. The optical circulator 330 may be any passive optical device with three or more ports in which the ports can be accessed in such an order that when a signal is fed into any port it is transferred to the next port, the first port being counted as following the last in numeric order. The optical circulator 330 may receive the second downstream branched signal from a first port, and retransmit the second downstream branched signal from a second port to the FP LD 340. The second branched downstream signal may be used at the FP LD 340 as “seed” light to trigger injection-locking. The injection-locked FP LD 340 provides the upstream optical signal. The upstream signal may be transmitted from the FP LD to the optical circulator 330 through the second port. The optical circulator 330 may then transmit the upstream signal from third port to the ODN.

Another embodiment of the ONU 300 is shown in FIG. 3B. The FP LD 340 may be replaced by a VCSEL 350. A VCSEL 350 may be another type of laser that makes use of injection-locking to provide a single-wavelength optical signal. The VCSEL 350 receives the second branched downstream signal from the second port of the optical circulator 330. This downstream signal is used as “seed” for injection-locking at the VCSEL 350. The VCSEL 560 may transmit the upstream wavelength signal with the customer data to the optical circulator 330 at the second port. The optical circulator 330 may then transmit the upstream wavelength signal through the third port to the ODN.

In another embodiment shown in FIG. 3C, a semiconductor optical amplifier (SOA) 360 may substitute for the VCSEL 350 as an injection-locking component. The SOA 360 may be any optical amplifier that uses a semiconductor to provide the gain medium. The SOA 360 may be similar in structure to the FP LD 340 but with anti-reflection design elements at the end-facets. The SOA 360 may also be similar in structure to the VCSEL 350, such as in the case of a vertical cavity SOA (VCSOA). The SOA 360 may receive the “seed” branched downstream signal from the optical circulator 330 and transmit the amplified upstream signal.

FIG. 3D illustrates yet another embodiment of the colorless ONU 300, wherein a reflective semiconductor optical amplifier (RSOA) 370 is used as the injection-locking component. The RSOA 370 is a semiconductor based optical amplifier with similar characteristics to the SOA 360. The RSOA 370 however may comprise a single combined input/output port. In this embodiment, the optical circulator 330 may receive a downstream wavelength signal through the first port directly from the ODN in the absence of the 1×2 coupler 310. The optical circulator may send the downstream wavelength signal through the second port to the RSOA 370. The RSOA 370 may have an integrated optical receiver that receives the downstream wavelength signal instead of the receiver 320. Furthermore, the RSOA 370 may use the downstream wavelength signal as “seed” light for injection-locking, and resend the amplified upstream wavelength signal with the customer data to the optical circulator 330 through the second port. The optical circulator 330 may then transmit the upstream wavelength signal to the ODN.

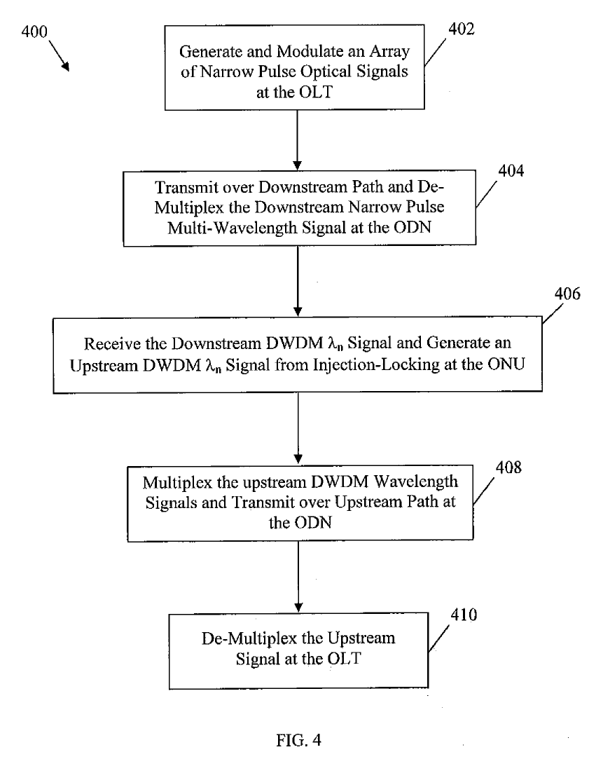

FIG. 4 illustrates one embodiment of a method 400 of implementing a WPON system with colorless ONUs and a single model-locked laser at the OLT. At block 402, the method 400 comprises generating and modulating a narrow pulse signal at the OLT using the single model-locked laser in the manner described above. At block 404, the narrow pulse signal with multi-wavelength may be transmitted over a downstream path at the ODN, where the pulse may be de-multiplexed into combined wavelength channels. At block 406, the individual wavelength channels may be received by the ONUs. At the ONU, the one wavelength signal may be used as “seed” for injection-locking and transmission of upstream data at the same wavelength. At block 408, the upstream wavelength channels may be multiplexed and transmitted over an upstream path. At block 410, the upstream DWDM signal may be further de-multiplexed into wavelength signals and collected at the OLT. In another embodiment, a first generated narrow pulse signal may be de-multiplexed into wavelength components at the OLT, wherein each wavelength component is modulated individually. The modulated wavelength components may then be re-multiplexed and may be transmitted downstream at the ODN.

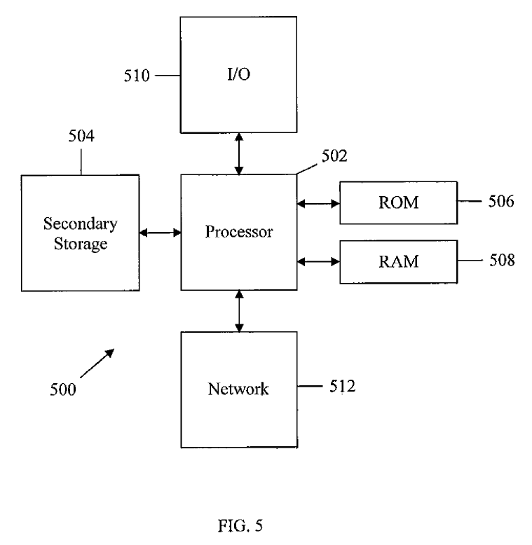

The network described above may be implemented on any general-purpose network component, such as a computer or network component with sufficient processing power, memory resources, and network throughput capability to handle the necessary workload placed upon it. FIG. 5 illustrates a typical, general-purpose network component suitable for implementing one or more embodiments of a node disclosed herein. The network component 500 includes a processor 502 (which may be referred to as a central processor unit or CPU) that is in communication with memory devices including secondary storage 504, read only memory (ROM) 506, random access memory (RAM) 508, input/output (I/O) 510 devices, and network connectivity devices 512. The processor may be implemented as one or more CPU chips, or may be part of one or more application specific integrated circuits (ASICs).

The secondary storage 504 is typically comprised of one or more disk drives or tape drives and is used for non-volatile storage of data and as an over-flow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage. The RAM 508 is used to store volatile data and perhaps to store instructions. Access to both ROM 506 and RAM 508 is typically faster than to secondary storage 504.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, optically, mechanically, or otherwise. Other examples of changes, substitutions, and alterations are ascertainable by one skilled in the art and could be made without departing from the spirit and scope disclosed herein.

What is claimed is:

1. A passive optical network component comprising:
a model-locked laser;
a dispersive nonlinear fiber coupled to the model-locked laser; and
a modulator coupled to the dispersive nonlinear fiber,
wherein the model-locked laser provides wavelengths for downstream modulations and enables upstream transmissions from a colorless optical network unit (ONU).

2. The component of claim 1 wherein the dispersive nonlinear fiber is a high dispersion fiber.

3. The component of claim 1 further comprising an optical router coupled to the modulator.

4. The component of claim 3 wherein the optical router is an arrayed waveguide grating (AWG) router or a thin film filter.

5. The component of claim 1 further comprising:
a first optical router positioned upstream of the modulator; and
a second optical router positioned downstream of the modulator.

6. The component of claim 1 further comprising:
an optical router; and
a receiver array coupled to the optical router.

7. The component of claim 1 wherein the OLT does not comprise a broadband light source.

8. A colorless optical network unit (ONU) comprising:
an optical circulator coupled to an incoming optical path and an outgoing optical path; and
an optical injection-locking component coupled to the optical circulator,
wherein the colorless ONU uses downstream optical signals from a model-locked laser as seed light to enable colorless upstream transmissions.

9. The colorless ONU of claim 8 further comprising:
an optical coupler coupled to the incoming optical path and the optical circulator; and
an optical receiver coupled to the optical coupler.

10. The colorless ONU of claim 8 wherein the coupler is a 1×2 coupler.

11. The colorless ONU of claim 8 wherein the optical injection-locking component is a Fabry-Perot laser diode.

12. The colorless ONU of claim 8 wherein the optical injection-locking component is a vertical-cavity surface-emitting laser.

13. The colorless ONU of claim 8 wherein the optical injection-locking component is a semiconductor optical amplifier.

14. The colorless ONU of claim 8 wherein the optical injection-locking component is a reflective semiconductor optical amplifier.

15. The colorless ONU of claim 8 wherein the incoming optical path and the outgoing optical path carry optical signals having substantially the same wavelength.

16. A method comprising:
generating an optical pulse comprising a plurality of wavelengths using a model-locked laser;
modulating the optical pulse at at least one of the wavelengths; and
transmitting the modulated optical pulse to an optical component on an outgoing path, wherein the optical pulse induces injection-locking in the optical component for transmission to an incoming path.

17. The method of claim 16 further comprising:
separating at least some of the wavelengths in the optical pulse prior to modulation.

18. The method of claim 17 further comprising:
recombining the wavelengths in the optical pulse subsequent to modulation.

19. The method of claim 16 further comprising:
separating at least some of the wavelengths in the optical pulse subsequent to modulation.

20. The method of claim 16 further comprising:
receiving a second optical signal on the incoming path, wherein the second optical signal has at least some wavelengths in common with the optical pulse.
